(19) United States
(12) Patent Application Publication
(10) Pub. No.: US 2024/0367738 A1
(43) Pub. Date: Nov. 7, 2024

(54) MODULAR CHASSIS

(71) Applicant: Cummins Inc., Columbus, IN (US)

(72) Inventors: Jacob Ensign, Rogue River, OR (US); Brendan J. O’Grady, Columbus, IN (US)

(21) Appl. No.: 18/654,903

(22) Filed: May 3, 2024

Related U.S. Application Data
(60) Provisional application No. 63/464,356, filed on May 5, 2023.

(51) Int. Cl. B62D 63/02; B60K 1/04; B60K 11/00; B60L 50/60; B60L 50/71

(52) U.S. Cl. CPC B62D 63/025; B60K 1/04; B60K 11/00; B60L 50/66; B60L 50/71

(57) ABSTRACT

A modular chassis with one or more modular packs configured to couple to an adjacent modular pack and/or subframe to form a modular chassis for a vehicle. Each of the one or more modular packs may be configured to contain and carry or otherwise support a subsystem, a component, or a component of a subsystem for operation of the vehicle. One or more modular packs within a modular chassis may be empty and serve only a support or structural function for the modular chassis.

### CROSS-REFERENCE TO RELATED APPLICATION

This application claims priority to U.S. Provisional Application No. 63/464,356, filed on May 5, 2023, the disclosure of which is hereby incorporated by reference in its entirety.

### TECHNICAL FIELD OF THE DISCLOSURE

The present disclosure relates to a vehicle chassis. The present disclosure further relates to vehicle chassis of a scalable modular design.

### BACKGROUND OF THE DISCLOSURE

An increasing number of vehicles have alternative or hybrid powertrains and/or drivetrains, requiring the corresponding vehicular structure to accommodate an appropriate number of battery packs, fuel cells, and/or additional components for vehicular size, load, route distance, etc. Retrofitting of existing chassis designed for internal combustion engines limits design and size of the alternative and/or hybrid powertrains.

### SUMMARY OF THE DISCLOSURE

The present disclosure provides a modular chassis with one or more modular packs configured to couple to an adjacent modular pack and/or subframe to form a modular chassis for a vehicle. Each of the one or more modular packs may be configured to contain and carry or otherwise support a subsystem, a component, or a component of a subsystem for operation of the vehicle. One or more modular packs within a modular chassis may be empty and serve only a support or structural function for the modular chassis. In a first aspect of the disclosure a vehicle battery chassis is disclosed, the chassis including a front subframe, a first battery pack positioned immediately adjacent the front subframe, a rear subframe, a last battery pack positioned immediately adjacent the rear subframe, and a side tie plate coupled to the front subframe, the first battery pack, and the rear subframe.

In a second aspect of the disclosure, a modular chassis for a vehicle is disclosed. The modular chassis includes a plurality of modular packs, a first main rail coupled to each modular pack of the plurality of modular packs so that each modular pack of the plurality of modular packs is arranged linearly relative to an adjacent modular pack, and a second main rail coupled to each modular pack of the plurality of modular packs opposite of the first main rail. At least one modular pack of the plurality of modular packs includes a subsystem or a component of a subsystem of a vehicle.

In a third aspect of the disclosure, a modular chassis for a vehicle is disclosed. The modular chassis includes a first subframe, a first modular pack positioned immediately adjacent the first subframe, a second subframe, and a side tie plate coupled to the first subframe, the first modular pack, and the second subframe.

In a fourth aspect of the disclosure, a modular pack for a chassis of a vehicle is disclosed. The modular pack includes a first wall, a second wall coupled to and forming an angle with the first wall, a third wall coupled to and forming an angle with the second wall, and a fourth wall coupled to and forming an angle with the first wall and the third wall. The third wall is spaced apart from the first wall a distance corresponding with a length of the second wall. The modular pack also includes a bottom panel extending between and coupled to the first wall, the second wall, the third wall, and the fourth wall. The modular pack also includes a cap extending between and coupled to the first wall, the second wall, the third wall, and the fourth wall. The cap is spaced apart from the bottom panel a distance corresponding with a height of at least one of the first wall, the second wall, the third wall, and the fourth wall. An interior enclosure is defined by the first wall, the second wall, the third wall, the fourth wall, the bottom panel, and the cap. The modular pack also includes a first rail extending across the interior enclosure between the first wall and the third wall. The first rail also extends in a first direction from the first wall exterior of the interior enclosure to define a first coupling section of the first rail and in a second direction from the third wall exterior of the interior enclosure to define a second coupling section of the first rail.

In various aspects of the disclosure, the chassis may further include a bottom closeout removably coupled to the front subframe, the first battery pack, and the rear subframe.

In various aspects of the disclosure, the chassis may include a plurality of battery pack modules. Each of the plurality of battery pack modules may be directly coupled to an immediately adjacent battery pack module via a fastening assembly. The fastening assembly may include a first portion and a second portion, each of the first portion and the second portion including a wedge having a concave portion, and a vertical tie bolt extending from the first portion to the second portion.

In various aspects of the disclosure, the chassis may further include a route-controlled pack vent having an inlet corresponding with a pack vent of the first battery pack.

In various aspects of the disclosure, the rear subframe may include two axles.

In various aspects of the disclosure, the front subframe may include a first main rail, a second main rail, and a plurality of crossrails extending from the first main rail to the second main rail.

In various aspects of the disclosure, the chassis may include a first controller mounted on the front subframe and a second controller mounted on the rear subframe.

In various aspects of the disclosure, a length of the modular chassis may be defined by a number of modular packs included in the plurality of modular packs, and the length of the modular chassis may define a length of the vehicle.

In various aspects of the disclosure, the subsystem or the component of a subsystem of the vehicle may be at least one of: a battery pack, a battery pack module, a thermal management system, a fuel cell system, an e-axle system, and a traction drive system.

In various aspects of the disclosure, the subsystem or the component of a subsystem may be mounted on an exterior surface of the at least one modular pack of the plurality of modular packs.

In various aspects of the disclosure, the first main rail may be a side tie plate coupled to an exterior sidewall of each modular pack of the plurality of modular packs.

In various aspects of the disclosure, the first main rail may be comprised of a plurality of first rails, each first rail extending through a forward-facing wall, an interior enclosure, and a rear-facing wall of one modular pack of the plurality of modular packs to couple with an adjacent first rail of an adjacent modular pack. Each first rail may include a plurality of fastener holes so that a distance between the one modular pack of the plurality of battery packs and the adjacent modular pack is adjustable.

In various aspects of the disclosure, the at least one modular pack of the plurality of modular packs may be a first modular pack, and the subsystem or the component of a subsystem of the vehicle may be a first subsystem or a first component of a subsystem of the vehicle. A second modular pack of the plurality of modular packs may include a second subsystem or a second component of a subsystem of the vehicle. The second subsystem or the second component of a subsystem of the vehicle may be different from the first subsystem or the first component of a subsystem of the vehicle.

In various aspects of the disclosure, the at least one modular pack of the plurality of modular packs may include a second subsystem or a second component of a subsystem of the vehicle.

In various aspects of the disclosure, the modular chassis may further include a bottom closeout removably coupled to the first subframe, the first modular pack, and the second subframe.

In various aspects of the disclosure, the modular chassis may further include a plurality of modular pack modules. Each modular pack of the plurality of modular packs may be directly coupled to an immediately adjacent modular pack via a fastening assembly.

In various aspects of the disclosure, at least one of the first subframe and the second subframe may include a first main rail, a second main rail, and a plurality of crossrails extending form the first main rail to the second main rail.

In various aspects of the disclosure, the modular chassis may further include a controller mounted on at least one of the first subframe and the second subframe.

In various aspects of the disclosure, the first rail may be spaced apart from the second wall in a direction toward the fourth wall.

In various aspects of the disclosure, the modular pack may further include a second rail extending across the interior enclosure between the first wall and the third wall. The second rail may also extend in the first direction from the first wall exterior of the interior enclosure to define a first coupling section of the second rail and extend in the second direction from the third wall exterior of the interior enclosure to define a second coupling section of the second rail.

In various aspects of the disclosure, the bottom panel may define a hollow ridge extending into the interior enclosure.

Additional features and advantages of the present disclosure will become apparent to those skilled in the art upon consideration of the following detailed description of the illustrative embodiments exemplifying the disclosure as presently perceived.

### BRIEF DESCRIPTION OF THE DRAWINGS

The detailed description of the drawings particularly refers to the accompanying figures in which:

FIG. 1 illustrates a schematic example of a vehicle having a battery electric powertrain and various components of such vehicle;

FIG. 2 illustrates an embodiment of a modular chassis of the present disclosure, including a plurality of modular packs;

FIG. 3 is a partially exploded view of the modular chassis of FIG. 2;

FIG. 4 is a modular pack of the plurality of modular packs of the modular chassis of FIG. 2;

FIG. 5 is an exploded view of the modular pack of FIG. 4, including an exemplary battery pack included in some embodiments of the modular pack;

FIG. 6A is an up-close view of an upper portion of a fastening assembly for use with the modular pack of FIG. 5; and

FIG. 6B is an up-close view of a lower portion of the fastening assembly of FIG. 6A;

FIG. 7 illustrates another embodiment of a modular chassis of the present disclosure including a plurality of modular packs;

FIG. 8 is a second view of the modular chassis of FIG. 7, wherein some modular packs of the plurality of modular packs are in a transparent view to illustrate the interior of said modular packs;

FIG. 9 illustrates a top view of a modular pack of the plurality of modular packs of the modular chassis of FIG. 7;

FIG. 10 illustrates a bottom view of the modular pack of FIG. 9;

FIG. 11A is a schematic view of an exemplary arrangement of an interior enclosure of a modular pack consistent with the modular pack of FIG. 9;

FIG. 11B is a schematic view of another exemplary arrangement of an interior enclosure of a modular pack consistent with the modular pack of FIG. 9;

FIG. 11C is a schematic view of yet another exemplary arrangement of an interior enclosure of a modular pack consistent with the modular pack of FIG. 9; and

FIG. 11D is a schematic view of another exemplary arrangement of an interior enclosure of a modular pack consistent with the modular pack of FIG. 9.

Although the drawings represent embodiments of various features and components according to the present disclosure, the exemplification set out herein illustrates an embodiment, and such an exemplification is not to be construed as limiting the scope of the disclosure in any manner.

### DETAILED DESCRIPTION OF THE DRAWINGS

For the purposes of promoting an understanding of the principles of the present disclosure, reference will now be made to the embodiments illustrated in the drawings, which are described herein. The embodiments disclosed herein are not intended to be exhaustive or to limit the invention to the precise form disclosed. Rather, the embodiments are chosen and described so that others skilled in the art may utilize their teachings. Therefore, no limitation of the scope of the claimed invention is thereby intended. The present invention includes any alterations and further modifications of the illustrated devices and described methods and further applications of principles in the invention which would normally occur to one skilled in the art to which the invention relates.

The terms “couples”, “coupled”, “coupler” and variations thereof are used to include both arrangements wherein the two or more components are in direct physical contact and arrangements wherein the two or more components are not in direct contact with each other (e.g., the components are “coupled” via at least a third component), but yet still cooperate or interact with each other.

In some instances throughout this disclosure and in the claims, numeric terminology, such as first, second, third, fourth, etc., may be used in reference to various components of features. Such use is not intended to denote an ordering of the components or features. Rather, numeric terminology is used to assist the reader in identifying the components or features being referenced and should not be narrowly interpreted as providing a specific order of components of features.

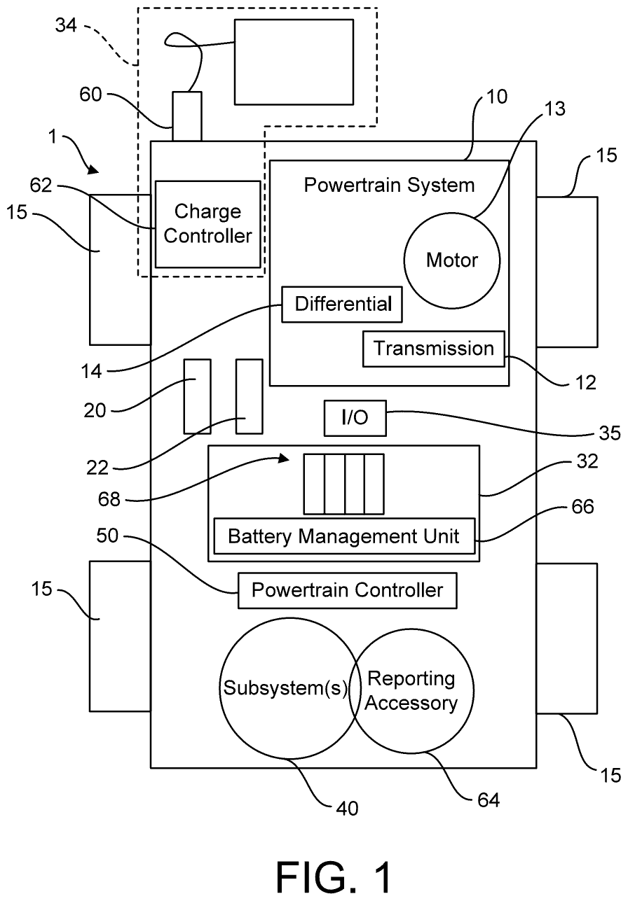

Referring initially to FIG. 1, a schematic diagram of a battery electric vehicle 1 is provided. While the vehicle is referred to as a battery electric vehicle, it is understood that the vehicle may include a hybrid vehicle, such as a plug-in hybrid vehicle, powered or otherwise operable via a battery and, optionally, one or more of a generator (e.g., a power generator, generator plant, electric power strip, on-board rechargeable electricity storage system, etc.) and a motor (e.g., an electric motor, traction motor, etc.). Battery electric vehicle 1 may be operable in at least one of a reverse direction (e.g., a backward direction relative to a front end of battery electric vehicle 1) and a non-reverse direction (e.g., a forward direction, angular direction, etc., relative to the front end of battery electric vehicle 1). Battery electric vehicle 1 may be an on-road or off-road vehicle including, but not limited to, cars, trucks, ships, boats, vans, airplanes, spacecraft, or any other type of vehicle.

Battery electric vehicle 1 comprises a powertrain controller 50 communicably and operatively coupled to a powertrain system 10, a brake mechanism 20, an accelerator pedal 22, one or more sensors, an operator input/output (I/O) device 35, and one or more additional vehicle subsystems 40. Battery electric vehicle 1 may include additional, fewer, and/or different components systems than depicted in FIG. 1, such that the principles, methods, systems, apparatuses, processes, and the like of the present disclosure are intended to be applicable with any suitable vehicle configuration. It should also be understood that the principles of the present disclosure should not be interpreted to be limited to on-highway vehicles; rather, the present disclosure contemplates that the principles may also be applied to a variety of other applications including, but not limited to, off-highway construction equipment, mining equipment, marine equipment, locomotive equipment, etc.

Powertrain system 10 facilitates power transfer from a battery 32 and/or a motor 13 to power battery electric vehicle 1. In an exemplary embodiment, powertrain system 10 includes motor 13 operably coupled to battery 32 and charge system 34, where motor 13 transfers power to a final drive (e.g., wheels 15) to propel battery electric vehicle 1. As depicted, powertrain system 10 may include other various components, such as a transmission 12 and/or differential 14, where differential 14 transfers power output from transmission 12 to final drive 15 to propel battery electric vehicle 1. Powertrain controller 50 of battery electric vehicle 1 provides electricity to motor 13 (e.g., an electric motor) in response to various inputs received by powertrain controller 50, for example, from accelerator pedal 22, sensors, vehicle subsystems 40, charge system 34 (e.g., a battery charging system, rechargeable battery, etc.). In some embodiments, electricity provided to power motor 13 may be provided by an onboard gasoline-engine generator, a hydrogen fuel cell, etc.

In some embodiments, battery electric vehicle 1 may include transmission 12. Transmission 12 may be structured as any type of transmission compatible with battery electric vehicle 1, including a continuous variable transmission, a manual transmission, an automatic transmission, an automatic-manual transmission, or a dual clutch transmission, for example. Accordingly, as transmissions vary from geared to continuous configurations, transmission 12 may include a variety of settings (e.g., gears, for a geared transmission) that affect different output speeds based on an engine speed or motor speed. Like transmission 12, motor 13, differential 14, and final drive 15 may be structured in any configuration compatible with battery electric vehicle 1. In some embodiments, transmission 12, is omitted and motor 13 is directly coupled to differential 14. In other embodiments, motor 13 is directly coupled to final drive 15 as a direct drive application. In some examples, battery electric vehicle may comprise multiple instances of motor 13, for example, one instance for each driven wheel, one instance per driven axle, or other compatible arrangements.

Brake mechanism 20 may be implemented as a brake (e.g., hydraulic disc brake, drum brake, air brake, etc.), braking system, or any other device configured to prevent or reduce motion by slowing or stopping components (e.g., a wheel, axle, pedal, crankshaft, driveshaft, etc. of battery electric vehicle 1). Generally, brake mechanism 20 is configured to receive an indication of a desired change in the vehicle speed. In some embodiments, brake mechanism 20 comprises a brake pedal operable between a released state and an applied state by an operator of battery electric vehicle 1. The brake pedal may be configured as a pressure-based system responsive to applied pressure or a travel-based system responsive to a travel distance of the pedal, where a force applied to brake mechanism 20 is proportional to the pressure and/or travel distance. In some embodiments, all or a portion of brake mechanism 20 is incorporated into motor 13, for example, as a regenerative brake mechanism.

Generally, the released state of brake mechanism 20 corresponds to a brake pedal in a default location where the brake mechanism is not applied, for example, when the operator's foot is not placed on the brake pedal at all, or merely resting on the brake pedal such that a minimum actuation force is not exceeded (e.g., a spring-assisted, hydraulic-assisted, or servo-assisted force that pushes the brake pedal to the default location). In some embodiments, the brake pedal is combined with accelerator pedal 22 in a one-pedal driving configuration. In some examples, the applied state of brake mechanism 20 may correspond to the brake pedal being pressed with a force that meets or exceeds the minimum actuation force. In other examples, the applied state of brake mechanism 20 corresponds to the brake pedal being pressed so that the travel distance of the brake pedal meets or exceeds a minimum travel distance. Generally, the minimum actuation force and/or minimum travel distance help to prevent accidental actuation of brake mechanism 20. Different levels of the minimum actuation force and/or minimum travel distance may be used for different implementations of brake mechanism 20, for example, relatively higher forces or travel distance for a foot-actuated brake pedal, relatively lower forces or travel distance for a hand-actuated brake lever. Although the brake pedal may have a range of pressures and/or travel distances that provide at least some braking effect on battery electric vehicle 1 (e.g., high pressures for hard or emergency braking, low pressures for gradual braking or “feathering” the brakes), this range of pressures and/or travel distances are within the applied state.

The released state may correspond to an indication of a desired increase in vehicle speed, while the applied state may correspond to an indication of a desired reduction in vehicle speed. In some embodiments, a reduction in actuation force and/or travel distance corresponds to a desired increase in vehicle speed, while an increase in actuation force and/or travel distance corresponds to a desired reduction in vehicle speed.

Accelerator pedal 22 may be structured as any type of torque and/or speed request device included with a system (e.g., a floor-based pedal, an acceleration lever, paddle or joystick, etc.). Sensors associated with accelerator pedal 22 and/or brake mechanism 20 may include a vehicle speed sensor that provides a vehicle speed signal corresponding to a vehicle speed of battery electric vehicle 1, an accelerator pedal position sensor that acquires data indicative of a depression amount of the pedal (e.g., a potentiometer), a brake mechanism sensor that acquires data indicative of a depression amount (pressure or travel) of brake mechanism 20, a coolant temperature sensor, a pressure sensor, an ambient air temperature, or other suitable sensors.

Battery electric vehicle 1 may include operator I/O device 35. Operator I/O device 35 may enable an operator of the vehicle to communicate with battery electric vehicle 1 and/or powertrain controller 50. Analogously, operator I/O device 35 enables battery electric vehicle 1 and/or powertrain controller 50 to communicate with the operator. For example, operator I/O device 35 may include, but is not limited to, an interactive display (e.g., a touchscreen) having one or more buttons, input devices, haptic feedback devices, an accelerator pedal, a brake pedal, a shifter or other interface for transmission 12, a cruise control input setting, a navigation input setting, or other settings or adjustments available to the operator. Via operator I/O device 35, powertrain controller 50 can also provide commands, instructions, and/or information to the operator or a passenger.

Battery electric vehicle 1 includes one or more vehicle subsystems 40, which may generally include one or more sensors (e.g., a speed sensor, ambient pressure sensor, temperature sensor, etc.), as well as any other subsystem that may be included with a vehicle. Vehicle subsystems 40 may also include torque sensors for one or more of motor 13, transmission 12, differential 14, and/or final drive 15. Other vehicle subsystems 40 may include a steering subsystem for managing steering functions, such as electrical power steering, and output information such as wheel position and fault codes corresponding to steering battery electric vehicle 1; an electrical subsystem which may include audio and visual indicators, such as hazard lights and speakers configured to emit audible warnings, as well as other functions; and a thermal management system, which may include components such as a radiator, coolant, pumps, fans, heat exchangers, computing devices, and associated software applications. Battery electric vehicle 1 may include further sensors other than those otherwise discussed herein, such as cameras, LIDAR, and/or RADAR, temperature sensors, smoke detectors, virtual sensors, among other potential sensors.

Powertrain controller 50 may be communicably and operatively coupled to powertrain system 10, brake mechanism 20, accelerator pedal 22, operator I/O device 35, and one or more vehicle subsystems 40. Communication between and among the components may be via any number of wired or wireless connections. For example, a wired connection may include a serial cable, a fiber optic cable, an SAE J1939 bus, a CAT5 cable, or any other form of wired connection. In comparison, a wireless connection may include the Internet, Wi-Fi, Bluetooth, Zigbee, cellular, radio, etc. In one embodiment, a controller area network (CAN) bus including any number of wired and wireless connections provides the exchange of signals, information and/or data. Powertrain controller 50 is structured to receive data (e.g., instructions, commands, signals, values, etc.) from one or more of the components of battery electric vehicle 1 as described herein via the communicable coupling of powertrain controller 50 to the systems and components of battery electric vehicle 1. In some embodiments, an additional or alternative controller may be used for receiving data from certain systems or components.

In vehicles including charge system 34, such as a plug-in charging system, battery electric vehicle 1 may powertrain controller 50 may control charging of battery 32 when a charger 60 of charge system 34 is connected to battery electric vehicle 1. A charge controller 62 establishes communications between powertrain controller 50 and charger 60. Charge controller 62 may receive a charge command from powertrain controller 50 and charger 60. Charge controller 62 may monitor sensor signals and perform safety and performance checks and determine faults based thereon. For example, charge controller 62 may determine a fault if charging has started but a physical connection between charger 60 and battery electric vehicle 1 fails to be detected or is detected to be outside safe boundaries. In other words, charge controller 62 may function as a communication interface between charger 60 and powertrain controller 50.

Powertrain controller 50 may be communicably coupled with charger 60, battery 32 and a reporting accessory 64 so that digital data may be transferred between components. Reporting accessory 64 may be include a vehicle subsystem 40 or another vehicle component. A CAN bus may be implemented to provide communications. In some embodiments, a first CAN bus may be implemented to provide communications between a first plurality of components while a second CAN bus may be implemented to provide communications between a second plurality of components. Any series or parallel communication scheme and protocol known in the arm may be implemented to provide communication.

Reporting accessory 64 may be operable to communicate information to powertrain controller 50. Such information may include identification, current demand, high or low voltage power draw, and other information required for operation of battery electric vehicle 1. Identification information may include a maximum current capacity of reporting accessory 64, for example. The current demand may be dynamic, such that the current demanded by reporting accessory 64 varies. Reporting accessory 64 may include an air-conditioning system, for example, and the current demand may vary based on a measured actual temperature of an interior of battery electric battery 1 compared to a target temperature. By reporting current demand to powertrain controller 50, reporting accessory 64 enables powertrain controller 50 to more accurately determine the target current to generate the charge command to charger 62. Comparatively, when the load of a non-reporting accessory is dynamic and unknown, charger 62 may underdeliver current to battery 32, extending charging time. The charge command may also take into account the charger's capability to deliver current and indicates to charger 62 the level of current to output to battery electric vehicle 1, which is ideally sufficient to optimally charge battery 32 and also power the accessories.

Battery 32 may include one or more battery packs including a battery management unit 66 and battery modules 68. FIG. 1 is not determinative of the number of battery modules within a battery pack or the number of battery packs within battery 32. Battery 32 may include a greater number of battery packs and/or a greater or lesser number of battery modules. Temperature, voltage, and other sensors may be provided to enable battery management unit 66 to manage the charging and discharging of battery modules 68 without exceeding their limits, to detect and manage faults, and to perform other known functions. Battery management unit 66 may transmit data to powertrain controller 50 related to information about battery 32, including the battery charge power limit, temperature, faults, etc. Battery 32 may include a current sensor to provide a measured current value to battery management unit 66, which may be used to affect the charge command provided to charger 62. The current sensor may be located elsewhere. Multiple current sensors may be used, each current sensor associated with a battery module of battery 32, where the sum of the measured currents being the measured current of battery 32.

Powertrain controller 50 may include a charge logic operable to determine a command for charger 62 to supply a target current to battery 32. The charge logic may also be integrated with a controller of battery management unit 66 or provided in a standalone controller communicatively coupled to powertrain controller 50. The term “logic” as used herein includes software and/or firmware comprising processing instructions executing on one or more programmable processors, application-specific integrated circuits, field-programmable gate arrays, digital signal processors, hardwired logic, or combinations thereof, which may be referred to as “controllers”. Therefore, in accordance with the disclosure, various logic may be implemented in any appropriate fashion. A non-transitory machine-readable medium comprising logic can additionally be included within any tangible form of a computer-readable carrier, such as a solid-state memory, containing an appropriate set of computer instructions and data structures that would cause a processor to carry out the techniques described herein. A non-transitory computer-readable medium, or memory, may include random access memory (RAM), read-only memory (ROM), erasable programmable read-only memory (e.g., EPROM, EEPROM, or Flash), or any tangible medium capable of storing information.

A transport control system and charging system may communicatively connect multiple chargers and control charging processes in a depot, linking charging points, power supplies, and operational information systems, such as planning and scheduling systems. The transport control system may provide the charging management system information such as estimated arrival time of vehicles, time available for charging, and scheduled pull-out time. The charging management system can then calculate the charging requirements for each vehicle and optimize charging processes for the fleet of vehicles to, for example, avoid expensive grid peak load periods where possible. The charging management system may also assign time slots for charging to each vehicle and monitor the progress of charging of each vehicle. The charging management system may receive from each vehicle an estimated time to full charge. In other embodiments, the vehicle may provide the relevant data to the charging management system, which may then estimate the time to full charge within its control logic.

Although FIG. 1 is described as illustrating a battery electric vehicle, the disclosure provided herein may also apply to vehicles having other powertrains, such as, for example, a plug-in hybrid vehicle. In such embodiments, the vehicle optionally includes an engine which may be structured as an internal combustion engine that receives a chemical energy input (e.g., a fuel such as natural gas, gasoline, ethanol, or diesel) from a fuel delivery system, and combusts the fuel to generate mechanical energy, in the form of a rotating crankshaft. In such an embodiment, transmission receives the rotating crankshaft and manipulates the speed of the crankshaft (e.g., the engine speed, which is usually expressed in revolutions-per-minute (RPM)) to affect a desired draft shaft speed. A rotating drive shaft may be received by differential, which provides the rotation energy from the drive shaft to final drive, which then propels or moves the vehicle.

The disclosure herein may further apply to vehicles, including battery electric or hybrid vehicles, which do not receive a charging plug. The disclosure may further apply to vehicles which are powered via fuel cell powertrains, in which case such vehicles may include fuel cells, fuel cell packs, fuel cell modules, hydrogen supplies including hydrogen tanks, balance of plant, and associated components in place of batteries and/or other powertrain components as described herein. Furthermore, in some embodiments, the disclosure herein may apply to internal combustion engine vehicles as described above without additional powertrain components such as batteries or fuel cells.

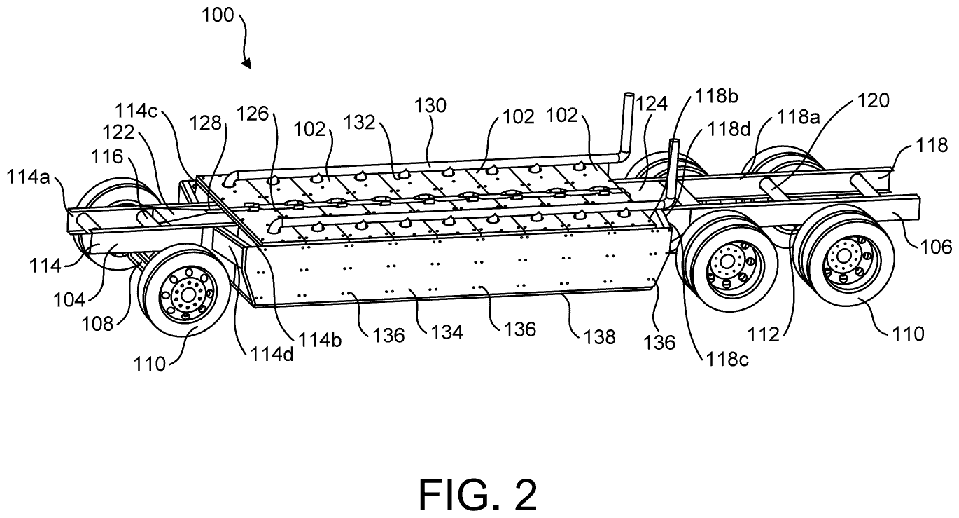

Referring initially to FIG. 2, a modular chassis 100 is illustrated. Modular chassis 100 includes a plurality of modular packs 102 illustratively arranged linearly along a length L of the battery pack chassis 100. Modular packs 102 may include, for example, battery packs. “Battery packs” as used herein may include either battery cells directly packaged as a pack, including battery cells directly packaged as a pack within a module body as described further herein, and/or or battery cells packed within a battery module, wherein the battery modules are packaged together as a battery pack within a module body. In other embodiments, modular packs 102 may include other or additional subsystems or components for operation of the vehicle.

The length L of modular chassis 100 is variable according to the needs of a corresponding vehicle. For example, a vehicle having a relatively greater length, a relatively greater load, and/or a relatively longer length may by equipped with a modular chassis 100 having a relatively longer length L. In other words, the number of modular packs 102 configured to be carried by modular chassis 100 is variable according to the needs of the corresponding vehicle.

Modular chassis 100 further includes a front subframe 104 positioned at a first end of modular chassis 100. Front subframe 104 is configured to correspond with a front end portion of the corresponding vehicle to facilitate attachment of modular chassis 100 to the corresponding vehicle. As illustrated, front subframe 104 may support a front axle 108 and corresponding wheels 110 associated with the drivetrain of the corresponding vehicle. In some embodiments, the traction system, including the motor and/or generator and/or inverter, may be mounted within the front axle 108 or otherwise mounted near the front axle 108. In other embodiments, the traction system may be a central drive system.

Front subframe 104 may generally be structured as a ladder, including two main rails 114 and a plurality of crossrails 116 positioned therebetween to provide support and structure to front subframe 104. In some embodiments, front subframe 104 may include a single crossrail 116. Main rails 114 may be L-shaped, including longitudinal portion 114a and lateral portion 114b, wherein lateral portion 114b is positioned adjacent to the foremost set of modular battery packs 102. Lateral portion 114b may include a flange 114c and a support beam 114d extending between flange 114c and longitudinal portion 114a to provide further structure and support to front subframe 104. Front subframe 104 may form other shapes which facilitate the assembly of battery pack chassis 100 as described further herein.

Modular chassis 100 also includes a rear subframe 106 positioned at a second end of modular chassis 100 opposite of front subframe 104. Rear subframe 106 is configured to correspond with a rear end portion of the corresponding vehicle to facilitate attachment of modular chassis 100 to the corresponding vehicle. As illustrated, rear subframe 106 may support at least one rear axle 112 and corresponding wheels 110 associated with the drivetrain of the corresponding vehicle. In some embodiments, rear subframe 106 may include two axles, as illustrated. In other embodiments, rear subframe 106 may include a greater number of axles necessary for appropriate operation of the corresponding vehicle. In some embodiments, the traction system, including the motor and/or generator and/or inverter, may be mounted within the rear axle 112 or otherwise mounted near the rear axle 112. In other embodiments, the traction system may be a central drive system.

Rear subframe 106 may be generally structured as a ladder, including two main rails 118 and a plurality of crossrails 120 positioned therebetween to provide support and structure to rear subframe 106. In some embodiments, rear subframe 106 may include a single crossrail 120. Main rails 118 may be L-shaped, including longitudinal portion 118a and lateral portion 118b, wherein lateral portion 118b is positioned adjacent to the rearmost set of modular battery packs 102. Lateral portion 118b may include a flange 118c and a support beam 118d extending between flange 118c and longitudinal portion 118a to provide further structure and support to rear subframe 106. Rear subframe 106 may form other shapes which facilitate the assembly of modular chassis 100 as described further herein.

A first controller 122 may be positioned within front subframe 104 between main rails 114. A second controller 124 may be positioned within rear subframe 106 between main rails 118. First controller 122 may include charging and/or subsystem controls, while second controller 124 may include motor and braking controls. In other embodiments, first controller 122 may include motor and braking controls, while second controller 124 may include charging and/or subsystem controls. The functions of first controller 122 and second controller 124 as provided herein are exemplary; in other words, first controller 122 and second controller 124 may have different functions as desired for operation of the corresponding vehicle.

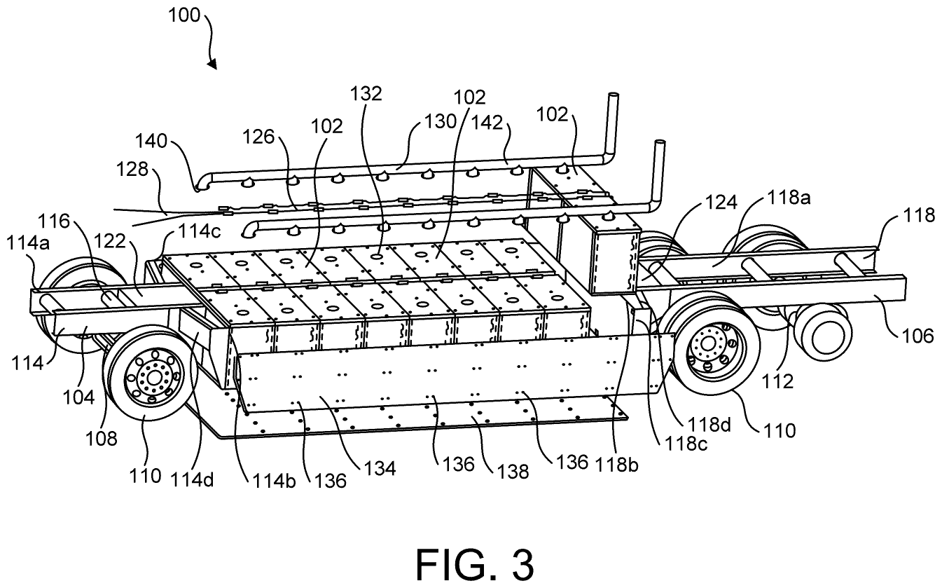

Referring additionally to FIG. 3, electrical lines 126 may run from first controller 122 to second controller 124 and electrically couple first controller 122 to second controller 124. Electrical lines 126 further couple each of first controller 122 and/or second controller 124 to each of the modular packs 102 as described further herein. While electrical lines 126 are illustratively ran along the top of modular packs 102 in FIGS. 2 and 3, electrical lines 126 may alternatively run beneath or beside modular packs 102 as permitted while substantially maintaining the structure of modular chassis 100 as described herein. Additionally, cooling lines 128 may run from front subframe 104 to rear subframe 106 along modular packs 102 to facilitate cooling of modular packs 102 during operation of the powertrain as described further herein.

Continuing to refer to FIGS. 2 and 3, modular chassis 100 may include a route-controlled pack vent 130 which connects each of the modular packs 102 in a linear arrangement via pack vent 132 of each of the corresponding modular packs 102. As illustrated in FIGS. 2 and 3, modular chassis 100 may have two route-controlled pack vents 130, for example, one corresponding with each battery stack within modular battery pack 102 as described further herein. In other embodiments, a single route-controlled pack vent 130 may be configured to fluidly couple with multiple pack vents 132 of each individual modular pack 102. Route controlled pack vent 130 has a plurality of inlets 140 to common duct 142 leading to an external outlet located away from modular chassis 100 and its associated modular packs 102. Each of the inlets 140 correspond to a pack vent 132 of modular pack 102, so that the route-controlled pack vent 130 is operable to vent modular packs 102 externally.

A side tie-plate 134 may be attached to front subframe 104, rear subframe 106, and each of the modular packs 102 to provide structural support to modular chassis 100, in part by coupling all of front subframe 104, rear subframe 106, and modular packs 102 to each other. Side tie-plate 134 may be coupled to front subframe 104, rear subframe 106, and/or each of the modular packs 102 using bolts or other mechanical fasteners 136. As illustrated, mechanical fasteners 136 may be positioned adjacent the foremost edge and the rearmost edge of each of the modular packs 102, at each lateral portion 114b, 118b, and at each flange 114c, 118c. In other embodiments, mechanical fasteners 136 may be positioned as desired to couple side tie-plate 134 to modular chassis 100. In some embodiments, side tie-plate 134 may be adhered, welded, or otherwise removably or fixedly coupled to front subframe 104, rear subframe 106, and/or each of the modular packs 102. Side tie-plate 134 also offers reinforced rigidity to modular chassis 100 by mitigating or eliminating unwanted torque and sag throughout the length L of modular chassis 100. Side tie-plate 134 may be formed of a puncture-resistant material to provide protection to modular packs 102 from damage caused by impact of another vehicle or debris. Puncture-resistant material may include steel, aluminum, plastic, and/or layered composite materials. Other puncture resistant materials may also be considered. A second side tie-plate may be positioned opposite modular chassis 100 from side tie-plate 134 and include similar features to those described relative to side tie-plate 134. In some embodiments, side tie-plate 134 and/or second side tie-plate 134 may be referred to as and/or serve a similar purpose as a main rail, such as a main rail described below in reference to modular chassis 200.

A bottom closeout 138 may be attached to front subframe 104, rear subframe 106, and/or each of the modular packs 102 to provide structural support to modular chassis 100. Bottom closeout 138 may also serve to support battery stacks of modular packs 102 as described further herein. Bottom closeout 138 may be removably coupled to front subframe 104, rear subframe 106, and/or each of the modular packs 102 using bolts or other mechanical fasteners 136. Bottom closeout 138 may be formed of a puncture-resistant material to provide protection to modular packs 102 from damage caused by road debris. Puncture-resistant material may include steel, aluminum, plastic, and/or layered composite materials. Other puncture resistant materials may also be considered.

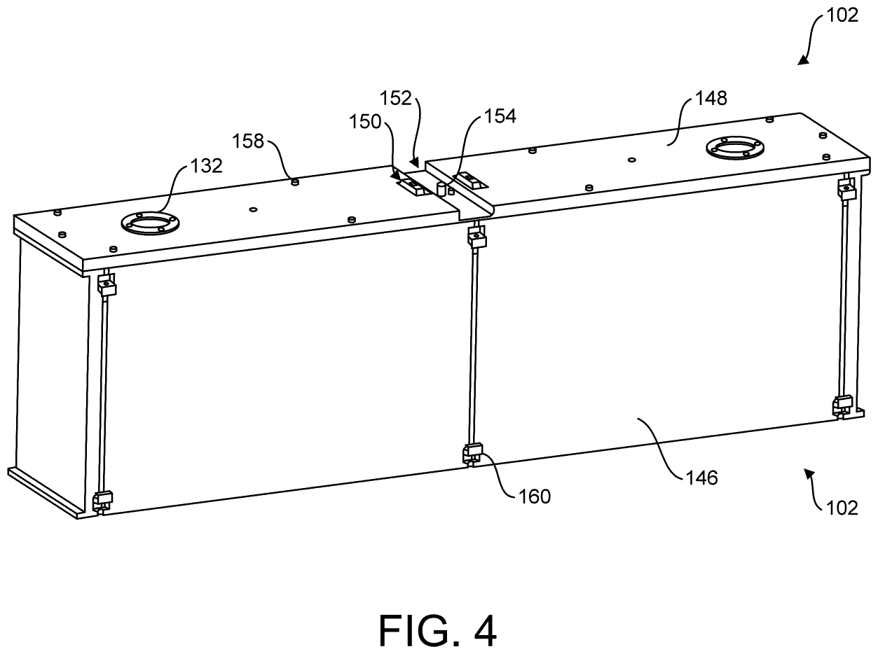

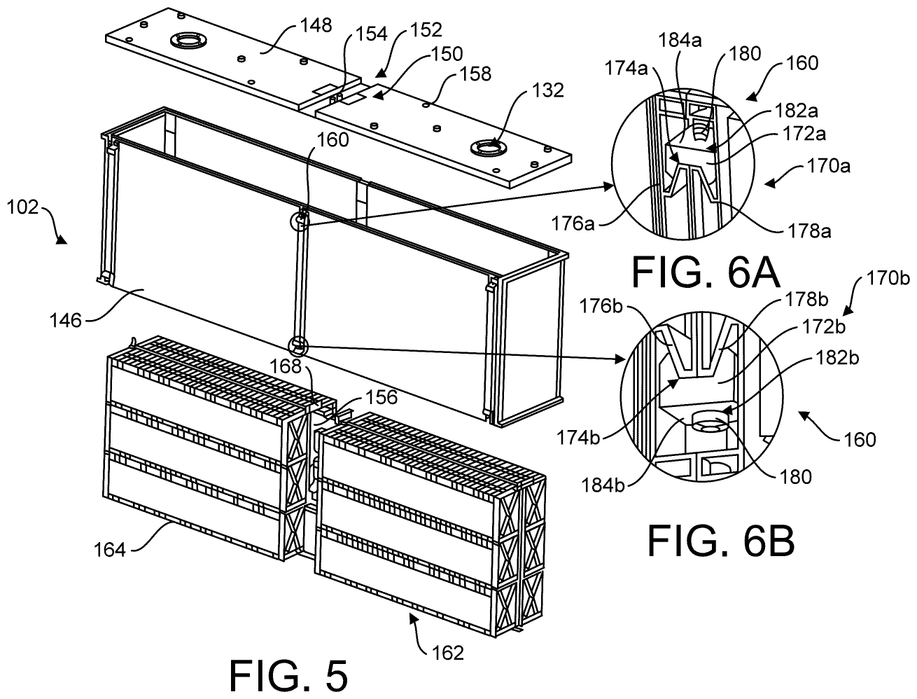

Now referring to FIG. 4, an assembled modular pack 102 is illustrated. Modular pack 102 includes a body 146 and a cap 148. Cap 148 may define at least one pack vent 132. Illustratively, cap 148 defines two pack vents 132, each pack vent 132 corresponding with a battery stack as described further herein. The number of pack vents 132 may vary dependent on the venting needs of modular pack 102. Cap 148 may further define electrical access 150 to provide direct electrical communication between electrical lines 126 described above with the corresponding battery stacks described further herein. A channel 152 is defined generally middle of cap 148, with cooling connections 154 positioned therein to facilitate cooling of modular pack 102 via cooling lines 128 and a cooling plate 156 (FIG. 5).

Cap 148 may be fastened to body 146 with mechanical fasteners 158 near the perimeter of cap 148. In other embodiments, cap 148 may be coupled to body 146 via other means, such as adhesive, welding, one-piece manufacturing, or other method as known in the art. Additional fasteners 158 may be used to couple corresponding cooling plates to the modular pack 102 to secure the cooling plates within modular pack 102 as described further herein. In other embodiments, additional fasteners 158 may be used to couple battery stacks and/or battery modules within modular pack 102. Fastening assemblies 160 may be positioned near each side and the general middle of body 146 of each modular pack 102 to facilitate coupling each modular pack 102 to adjacent modular pack(s) 102 as described further herein. As illustrated, each modular pack 102 shares six fastening assemblies 160 with each adjacent modular pack 102. In other embodiments, the number of fastening assemblies 160 may vary to facilitate a secure connection between modular packs 102, so that the connection between modular packs 102 functions as a cross rail for modular chassis 100.

Now referring to FIG. 5, an exploded view of a modular pack 102 configured to contain battery stacks is illustrated. Each modular pack 102 is illustratively configured to receive four battery stacks 162, each comprising three battery modules 164 and arranged in an 2×2 arrangement. Each of the battery stacks 162 may be mounted to a central cooling plate 166 in conductive contact with corresponding cooling connection 154 of the corresponding modular pack 102 when assembled. A battery management unit 168 may be positioned between battery stacks 162 and/or at either end of outer battery stacks 162. In other embodiments, each battery stack 162 may include a greater or lesser number of battery modules 164, e.g., one, two, four, five, six, etc. battery modules. In other embodiments, each modular pack 102 may be configured to receive a greater or lesser number of battery stacks 162, e.g., one, two, three, five, six, etc. battery stacks. In other words, the modular pack and corresponding chassis as described herein may be scaled to accommodate the needs of the corresponding vehicle. The arrangement of battery stacks within a scaled modular pack may vary as permitted by the chassis (e.g., 2×3, 3×3, 2×4, etc.).

When battery stacks 162 are positioned within body 146 and cap 148, central cooling plate 166 is in conductive contact with corresponding cooling connection 154 of cap 148 and configured to be operatively connected to cooling lines 128 (FIGS. 2, 3). Electrical connectors 168 of battery stacks 162 extend through corresponding electrical access 150 of cap 148 to couple with electrical lines 126 (FIGS. 2, 3) to place the battery stacks 162 in electrical communication with controllers 122, 124.

As described above, modular packs 102 couple to adjacent modular pack(s) 102 with fastening assemblies 160. An upper portion 170a of fastening assembly 160 is illustrated in FIG. 6A, while lower portion 170b of fastening assembly 160 is illustrated in FIG. 6B. Each of upper portion 170a and lower portion 170b includes a wedge 172a, 172b having a concave portion 174a, 174b configured to receive two corresponding half wedges 176a, 178a and 178a, 178b one from each of adjacent modular packs 102. As illustrated, a vertical tie bolt 180 is inserted into an aperture 182b defined by a lateral portion 184b of wedge 172b. Vertical tie bolt 180 extends along the longitudinal height H of body 146 of modular pack 102 and exits an aperture 182a defined by a lateral portion 184a of wedge 172a. Inserting vertical tie bolt 180 in a down-up manner allows for easy access to vertical tie bolt 180 from the bottom of modular chassis 100 to disconnect modular packs 102 from each other for servicing or replacement.

Referring to FIGS. 2-5, front subframe 104 is positioned adjacent to a first modular pack 102. One or more additional modular packs 102 may be coupled linearly to the first modular pack 102. A last modular pack 102 is positioned adjacent to rear subframe 106. Side tie plate 134 is aligned with and coupled to front subframe 104, rear subframe 106, and modular packs 102 as described above. A second side tie plate may be aligned with and coupled to front subframe 104, rear subframe 106, and modular packs 102 opposite modular chassis 100 from side tie plate 174. Battery stacks 172 are inserted into modular packs 102 and bottom closeout 138 is aligned with and coupled to front subframe 104, rear subframe 106, and modular packs 102 as described above. Bottom closeout 138 is removably coupled so that bottom closeout 138 can be easily removed so that a user can slide battery stacks 172 out of the bottom of modular battery packs 172 for easy removal and replacement.

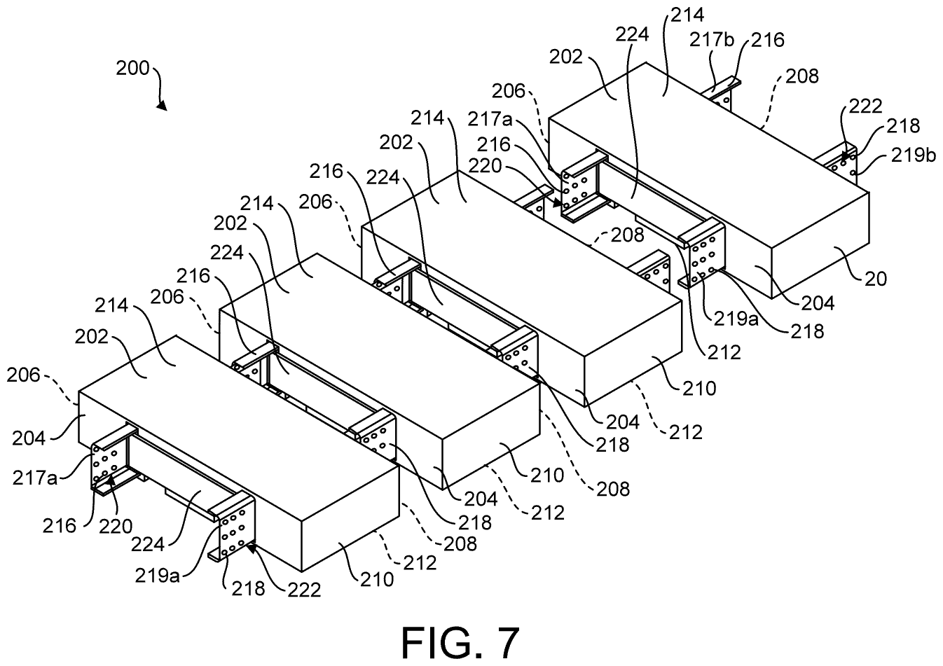

Now referring to FIG. 7, a modular chassis 200 for a vehicle is illustrated. Modular chassis 200 is configured to be coupled to or integrated with an existing vehicle frame to support operation of a corresponding vehicle. For example, rails of modular chassis 200 as described further herein may be fixedly, permanently, or removably coupled to or integrated with a vehicle frame for inclusion of modular chassis 200 with the corresponding vehicle. Modular chassis 200 may fit within the footprint of the vehicle frame in some embodiments. In other embodiments, modular chassis 200 may be wider than and/or longer than the footprint of the vehicle frame. In other embodiments, a new vehicle frame may be built around or integrally with modular chassis 200.

Modular chassis 200 includes a series of modular packs 202 linearly arranged to define a length of modular chassis 200. In other words, the number of modular packs 202 within modular chassis 200 is variable according to the desired length of modular chassis 200. Each modular pack 202 may be configured to receive and carry a component or subsystem of a corresponding vehicle. For example, each modular pack 202 may include one or more battery packs, thermal management systems and/or components, fuel cell systems and/or components, and/or other vehicle subsystems and/or components. For example, certain modular packs 202 may contain or package a traction motor, an inverter, an electric axle, or other subsystems and/or components. Some modular packs 202 may include air compressors, hydraulic pumps, fuel cell hardware, fuel storage systems, or other components. Other modular packs 202 may be included as structural packs only, i.e., they do not contain any subsystems or components for operation of the vehicle, but, instead, are only provided to facilitate structural support and/or length of the corresponding vehicle.

Each modular pack 202 is defined by a first wall, illustratively forward-facing wall 204; a second wall forming an angle with forward-facing wall 204, illustratively first sidewall 206; a third wall opposite of forward-facing wall 204 and spaced apart from forward-facing wall 204 by a length of first sidewall 206, illustratively rear-facing wall 208; and a fourth wall opposite first sidewall 206 and spaced apart from first sidewall 206 by a length of forward-facing wall 204 and rear-facing wall 208, illustratively second sidewall 210. A bottom panel 212 and a cap 214 cooperate with each of forward-facing wall 204, first sidewall 206, rear-facing wall 208, and second sidewall 210 to form an enclosure of modular pack 202, the enclosure configured to receive and hold a vehicle subsystem or serve, in part, as a structural component of modular chassis 200 as described above. Each of forward-facing wall 204, first sidewall 206, rear-facing wall 208, second sidewall 210, cap 214, and/or bottom panel 212 may be formed of a puncture-resistant material such as steel, aluminum, plastic, and/or layered composite materials. Other puncture resistant materials may also be considered. One or more walls of modular pack 202 is illustratively formed of a puncture and/or impact-resistant form of material to protect the component(s) and/or subsystem(s) that may be contained within modular pack 202. In some embodiments, any of forward-facing wall 204, first sidewall 206, rear-facing wall 208, second sidewall 210, bottom panel 212, and/or cap 214 may be removably coupled to the remaining walls to allow for access to an interior enclosure of modular pack 202 for service of subsystems and/or components contained therein.

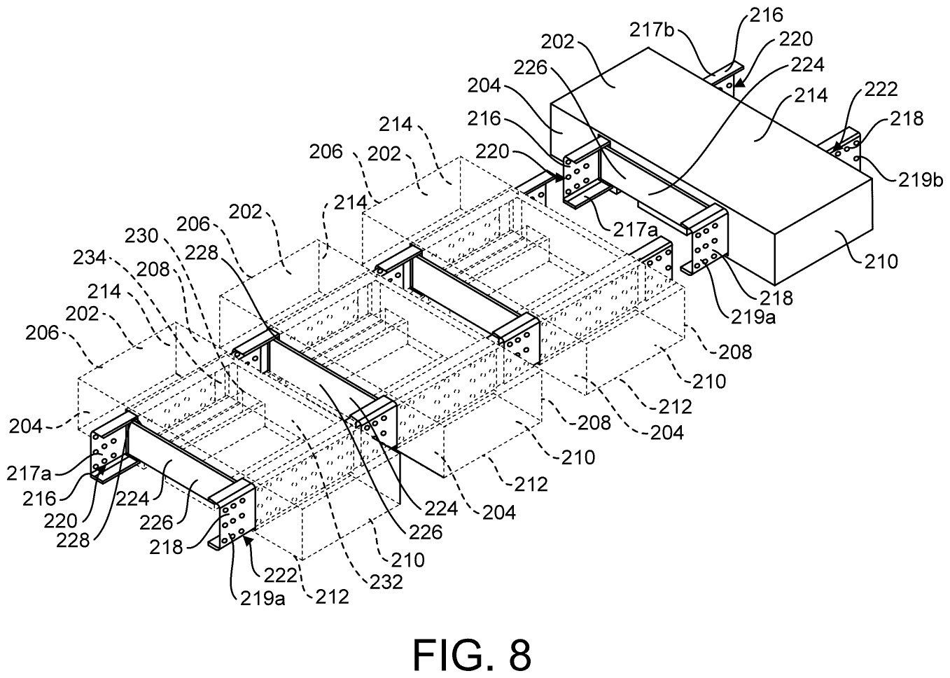

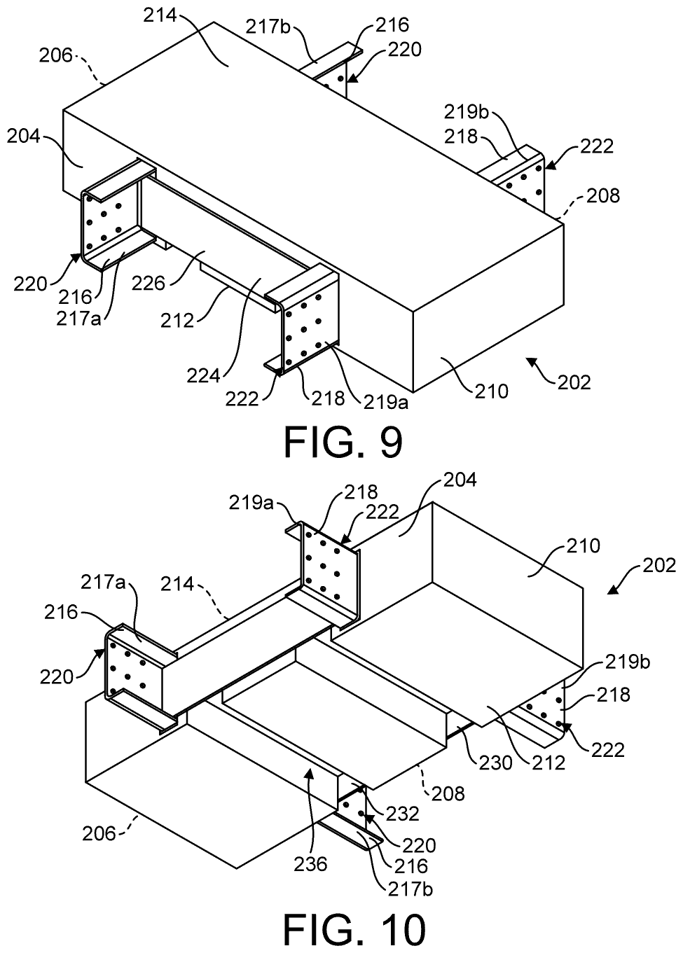

Referring additionally to FIGS. 8-9, each modular pack 202 includes a first rail 216 and a second rail 218 which extends through the enclosure defined by the modular pack 202. For example, first rail 216 and second rail 218 may each extend through modular pack 202 generally parallel to first sidewall 206 and/or second sidewall 210 but positioned inwardly of first sidewall 206 and second sidewall 210 relative to forward-facing wall 204 and rear-facing wall 208 so that the first rail 216 and second rail 218 traverse the enclosure defined by the modular pack 202 and intersect the forward-facing wall 204 and the rear-facing wall 208 as described further herein. First rail 216 of a first modular pack 202 may be configured to mate with first rail 216 of an adjacent modular pack 202, and second rail 218 of the first modular pack 202 may be configured to mate with second rail 218 of the adjacent modular pack 202 to couple the first modular pack 202 with the adjacent modular pack 202.

For example, first rail 216 of modular pack 202 may extend in a first direction from forward-facing wall 204 exterior of modular pack 202 to define a first coupling section 217a and extend in a second direction from rear-facing wall 208 exterior of modular pack 202 to define a second coupling section 217b. A first coupling section 217a of a first rail 216 of a corresponding modular pack 202 may be configured to receive or be received by an adjacent second coupling section 217b of a first rail 216 of an adjacent corresponding modular pack 202 so that one or more fastener holes 220 of the first coupling section 217a of first rail 216 and the one or more fastener holes 220 of the second coupling section 217b of adjacent first rail 216 align to receive a common fastener (not shown) to couple the first modular pack 202 with the adjacent modular pack 202. Similarly, second rail 218 of modular pack 202 may extend in a first direction from forward-facing wall 204 exterior of modular pack 202 to define a first coupling section 219a and extend in a second direction from rear-facing wall 208 exterior of modular pack 202 to define a second coupling section 219b. A first coupling section 219a of second rail 218 of a corresponding modular pack 202 may be configured to receive or be received by a second coupling section 219b of an adjacent second rail 218 of an adjacent corresponding modular pack 202 so that one or more fastener holes 222 of the first coupling section 219a of second rail 218 and the one or more fastener holes 222 of second coupling section 219b of adjacent second rail 218 align to receive a common fastener (not shown) to couple the first modular pack 202 with the adjacent modular pack 202. When a plurality of modular packs 202 are coupled together in such a manner, the collectively coupled first rails 216 may be referred to as a first main rail herein, and the collectively coupled second rails 218 may be referred to as a second main rail herein.

As illustrated, each of first rail 216 and second rail 218 have a C-shaped cross-section to facilitate the mating and alignment of the first rail 216 and/or second rail 218 of a first modular pack 202 with the first rail 216 and/or second rail 218 of an adjacent modular pack 202. Each of first rail 216 and second rail 218 may have a plurality of columns of fastener holes 220, 222, respectively, to allow for coupling of modular packs 202 with adjacent modular pack(s) at a selective distance as desired to customize the length of the modular chassis 200, for example, or to provide different, selective structural or support characteristics to modular chassis 200 where applicable. In other embodiments, first rail 216 and second rail 218 of a first modular pack 202 may couple to first rail 216 and second rail 218 of an adjacent modular pack 202 using other coupling techniques. For example, each of or one of first rail 216 and second rail 218 may have fewer or greater numbers of fastener holes 200, 220 than illustrated. In some embodiments, all or fewer of fastener holes 200, 220 may receive a fastener at any one time. In other embodiments first rail 216 and/or second rail 218 may be coupled to the first rail 216 and/or second rail 218 of adjacent modular pack 202 via adhesive, welding, snaps, tabs, or other coupling mechanisms, whether permanent or removable.

In some embodiments, first rail 216 and/or second rail 218 may have an alternative shape, including an I-beam shape, a simple straight shape, or another shape. In yet other embodiments, first rail 216 and/or second rail 218 may be positioned differently relative to first sidewall 206 and/or second sidewall 210 of modular pack 202. For example, first rail 216 may be positioned immediately adjacent to and/or touching an interior surface of first sidewall 206. In some embodiments, first rail 216 may be generally integral with first sidewall 206. In some embodiments, second rail 218 may be positioned immediately adjacent to and/or touching an interior surface of second sidewall 210. In some embodiments, second rail 218 may be generally integral with second sidewall 210.

A front bracket 224 may be coupled to forward-facing wall 204 of modular pack 202 and extending between first rail 216 and second rail 218. Front bracket 224 may provide additional support and structure to modular pack 202 while additionally maintaining the appropriate distance between first rail 216 and second rail 218 and providing additional support to first rail 216 and second rail 218. In some embodiments, front bracket 224 may include a central portion 226 which abuts forward-facing wall 204 of the corresponding modular pack 202 with two tabs 228 which are configured to couple with corresponding first rail 216 or second rail 218. Central portion 226 may directly contact forward-facing wall 204 of modular pack 202, or, in some embodiments, may be spaced apart from forward-facing wall 204 so that front bracket 224 is only directly coupled to first rail 216 and second rail 218 via tabs 228. In some embodiments, central portion 226 may be coupled to forward-facing wall 204 via adhesive, welding, mechanical fasteners, molding, snaps, tabs, or other known permanent or removable coupling techniques. Similarly, tabs 226 may be coupled to corresponding first rail 216 and second rail 218 via adhesive, welding, mechanical fasteners, molding, snaps, tabs, or other known permanent or removable coupling techniques.

A rear bracket 230 may be coupled to rear-facing wall 208 of modular pack 202 and extending between first rail 216 and second rail 218. Rear bracket 230 may provide additional support and structure to modular pack 202 while additionally maintaining the appropriate distance between first rail 216 and second rail 218 and providing additional support to first rail 216 and second rail 218. In some embodiments, rear bracket 230 may include a central portion 232 which abuts rear-facing wall 208 of the corresponding modular pack 202 with two tabs 234 which are configured to couple with corresponding first rail 216 or second rail 218. Central portion 232 may directly contact rear-facing wall 208 of modular pack 202, or, in some embodiments, may be spaced apart from rear-facing wall 208 so that rear bracket 230 is only directly coupled to first rail 216 and second rail 218 via tabs 234. In some embodiments, central portion 232 may be coupled to rear-facing wall 208 via adhesive, welding, mechanical fasteners, molding, snaps, tabs, or other known permanent or removable coupling techniques. Similarly, tabs 234 may be coupled to corresponding first rail 216 and second rail 218 via adhesive, welding, mechanical fasteners, molding, snaps, tabs, or other known permanent or removable coupling techniques.

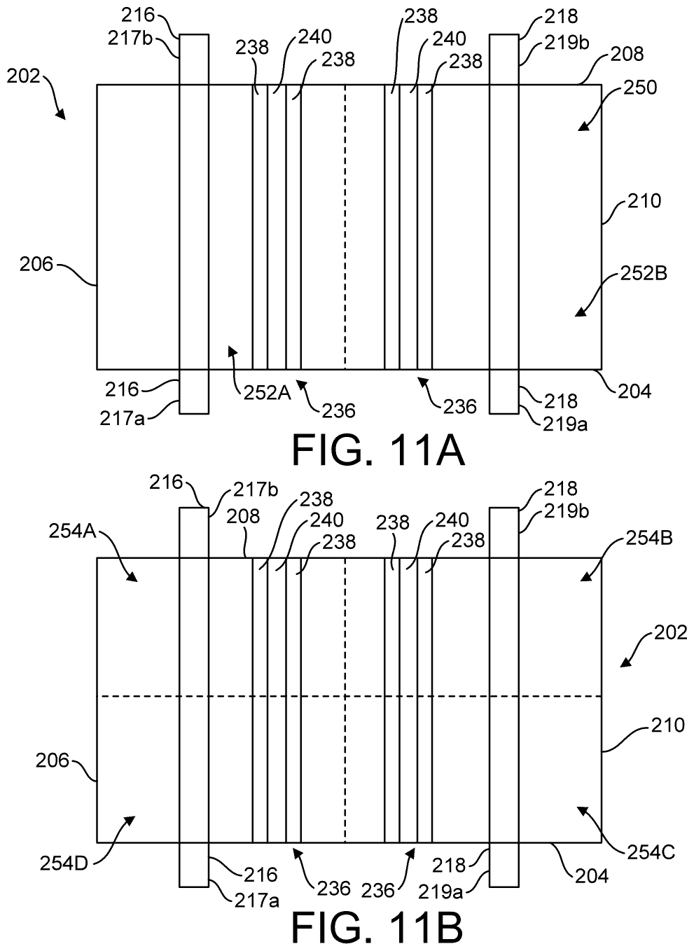

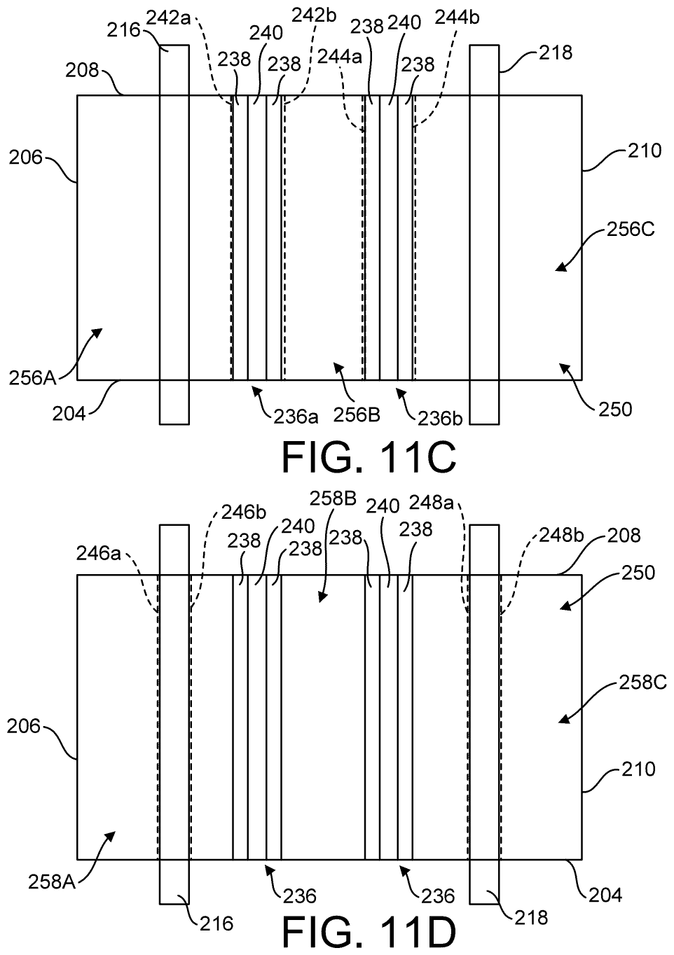

Now referring additionally to FIG. 10, bottom panel 212 of each modular pack 202 may define one or more, illustratively a pair of, hollow ridges 236, which extend up into the enclosure of corresponding modular pack 202. In other words, looking from an outside perspective, hollow ridges 236 form troughs in the bottom surface of bottom panel 212, while, looking from an inner perspective (e.g., FIGS. 11A-11D), hollow ridges 236 each form an upward tapering base 238 (FIGS. 11A-11D) ending in a peak 240 (FIGS. 11A-11D) extending from the floor of the enclosure of corresponding modular pack 202. The presence of such hollow ridges 236 may contribute to the support and structure provided by each modular pack 202.

As discussed above, each modular pack 202 may include one or more subsystems or subsystem components for operation of a corresponding vehicle including modular chassis 200. For example, modular pack(s) 202 of modular chassis 200 may include components related to a powertrain systems, traction systems, drivetrain systems, electrical operations systems, I/O systems, communication systems, and/or other systems and components, including batteries, battery packs, battery pack modules, battery management units, charging controllers, fuel cells, hydrogen tanks, balance of plant systems, internal combustion systems, inverters, traction motors, other controllers, memory, and/or other components necessary or useful for operation of the corresponding vehicle.

Some of the components mentioned above, such as and including battery packs and modules, when integrated into a vehicle, often require vibration isolation may be determined by the size, type, and application of the vehicle. For example, certain embodiments may require rigidly or fixedly mounting battery modules within modular pack 202 while other embodiments may integrate vibration isolation mechanisms with the battery modules within modular pack 202 depending on the battery type and requirements. In other words, modular packs 202 containing components and/or subsystems requiring additional components or special needs, such as vibration isolation, may include such additional components within the structure of the modular pack itself 202 or as an addition with said component and/or subsystem.

Arrangement of modular packs 202 within modular chassis 200 may be intentional. For example, a forward-most or rearward-most modular pack 202 of modular chassis 200 may be positioned closest to an axle of a drivetrain system of the corresponding vehicle and therefore house an e-axle or traction motor of the drivetrain system. Battery packs or battery pack modules may be situated in modular packs 202 closest to an electric motor of a vehicle. In some embodiments, some components or subsystems may be mounted on an external surface of modular pack(s) 202, e.g., on the cap 214 and/or bottom panel 212 as space allows and/or as arrangement may be advantageous for use of space and arrangement of components. In some embodiments, components or subsystems may be mounted on an external surface of any of forward-facing wall 204, first sidewall 206, rear-facing wall 208, and second sidewall 210 as space allows and/or as arrangement may be advantageous for use of space and arrangement of components. Such external mounting of such components and/or subsystems may be achieved via mechanical fasteners, adhesives, welding, use of brackets, integral manufacturing mechanisms, or other coupling or mounting mechanisms known in the art-removable or permanent.

Referring to FIGS. 11A-11D, exemplary schematic interior arrangements of modular pack(s) 202 are illustrated. For example, in some embodiments, referring to FIG. 11A, an interior enclosure 250 of modular pack 202 may be divided into a first section 252A and a second section 252B. In an embodiment having a two-part interior enclosure 250, a first component, subsystem, or set of components may be arranged within first section 252A while a second component, subsystem, or set of components may be arranged within second section 252B.

Similarly, referring to FIG. 11B, an interior enclosure 250 of modular pack 202 may be divided into first section 254A, a second section 254B, a third section 254C, and a fourth section 254D. In an embodiment having a four-part interior enclosure 250, a first component, subsystem, or set of components may be arranged within first section 254A; a second component, subsystem, or set of components may be arranged within second section 254B; a third component, subsystem, or set of components may be arranged within third section 254C; and/or a fourth component, subsystem, or set of components may be arranged within fourth section 254D. In some embodiments having a four-part interior enclosure, one or more sections 254A, 254B, 254C, and/or 254D may include one or more components, subsystems, or sets of components while one or more other sections may be left empty.

While the exemplary arrangements described in relation to FIGS. 11A and 11B generally illustrate equal division of space between sections covering the entire available space defined by interior enclosure 250, other embodiments may include sections which are not equal in shape and/or size. Some embodiments may include an alternative number of sections, including 1, 2, 3, 4, 5, 6, 7, 8, 9, 10, etc. sections. Some arrangements of interior enclosure 250 may leave empty space, including voids, channels, pathways, or other open areas to allow for installation of wiring, plumbing, air lines, hydraulic lines, or other strategic open spaces as desired or necessary to facilitate operation of contained components and/or subsystems or for weight distribution or other strategic arrangement of components and/or subsystems relative to the corresponding vehicle.

For example, referring to FIG. 11C, in some embodiments, interior enclosure 250 may be divided into a first section 256A, a second section 256B, and a third section 256C. First section 256A may be defined by forward-facing wall 204, first sidewall 206, rear-facing wall 208, and a first bottom edge 242a of upward-tapering base 238 of first hollow ridge 236a. Second section 256B may be defined by forward-facing wall 204, a second bottom edge 242b of upward-tapering base 238 of first hollow ridge 236a, rear-facing wall 208, and a first bottom edge 244a of upward-tapering base 238 of second hollow ridge 236b. Third section 256C may be defined by forward-facing wall 204, a second bottom edge 244b of upward-tapering base 238 of second hollow ridge 236b, rear-facing wall 208, and second sidewall 210.

First section 256A, second section 256B, and/or third section 256C may each be configured to contain one or more components, subsystems, and/or set of components as described above. With this arrangement, the interior enclosure space corresponding with first hollow ridge 236a and second hollow ridge 236b may be left as room for installation of wiring, plumbing, air lines, hydraulic lines, or other lines or cabling. One or more openings may be defined within forward facing wall 204 and/or rear facing wall 208 in general alignment with first hollow ridge 236a and/or second hollow ridge 236b to allow for said lines and/or cabling to run from the interior enclosure 250 to an exterior of the modular pack 202 and vice versa.

Similarly, referring to FIG. 11D, in some embodiments, interior enclosure 250 may be divided into a first section 258A, a second section 258B, and a third section 258C. First section 258A may be defined by forward-facing wall 204, first sidewall 206, rear-facing wall 208, and a first edge 246a of first rail 216. Second section 258B may be defined by forward-facing wall 204, a second edge 246b of first rail 216, rear-facing wall 208, and a first edge 248a of second rail 218. Third section 258C may be defined by forward-facing wall 204, second edge 248b of second rail 218, rear-facing wall 208, and second sidewall 210.

First section 258A, second section 258B, and/or third section 258C may each be configured to contain one or more components, subsystems, and/or set of components as described above. With this arrangement, the interior enclosure space corresponding with the width of the “C” shape in each of first rail 216 and second rail 218 may be left as room for installation of wiring, plumbing, air lines, hydraulic lines, or other lines or cabling. In other words, such lines or cabling may be ran along the interior of each of first rail 216 and/or second rail 218. One or more openings may be defined within forward facing wall 204 and/or rear facing wall 208 in general alignment with first rail 216 and/or second rail 218 to allow for said lines and/or cabling to run from the interior enclosure 250 to an exterior of the modular pack 202 and vice versa.

While various arrangements are described in relation to FIGS. 11A-11D above, it should be understood that such arrangements are exemplary by nature and various arrangements and changes to said arrangements may be made within the spirit and scope of the concept described. For example, the positioning of any voids, channels, or spaces, if desired, may be within any space of interior enclosure 250 as desired. Likewise, any described openings defined in any of the various walls of modular pack 202 may be otherwise positioned to allow for running of lines and/or cables and/or to allow access to the interior enclosure 250 from the exterior of modular pack 202 as desired. Furthermore, as described above, interior enclosure 250 may be divided into any number of sections of various shapes and sizes as befitting the use of each individual modular pack 202, including interior enclosures having one space that is not divided at all. Furthermore, each modular pack 202 of modular chassis 200 may have the same, similar, varying, or different arrangement from any, each, or all other modular packs 202 of the same or another modular chassis 200. One of various benefits of the use of such modular packs 202 and modular chassis 200 is the ability to arrange such modular packs 202 and/or modular chassis 200 in such a way as to fit the needs of the corresponding vehicle and/or desires of a user. As such, variances pertaining to the usage of the interior enclosure and/or arrangement of individual modular packs within a modular chassis are expected and included within the scope of the present disclosure.

While the system and methods herein have been described by reference to various specific embodiments it should be understood that numerous changes may be made within the spirit and scope of the concepts described. For example, in some embodiments having a general arrangement of modular packs 202 as described in reference to modular chassis 200, such embodiment may have side tie plates in addition to or instead of first rail 216 and second rail 218 may be included for additional support, structure, and/or protection of components and/or subsystems. In the same or other embodiments having a general arrangement of modular packs 202 as described in reference to modular chassis 200, a bottom closeout and/or a top closeout such as those described in reference to modular chassis 100 may be included for additional support, structure, and/or protection of components and/or subsystems. Other changes and/or alterations including the inclusion of features described in reference to modular chassis 100 being applied to modular chassis 200 or features described in reference to modular chassis 200 being applied to modular chassis 100 is within the scope of the disclosure. Accordingly, it is intended that the invention not be limited to the described embodiments but will have full scope defined by the language of the following claims.

What is claimed is:

1. A modular chassis for a vehicle, comprising:
a plurality of modular packs;
a first main rail coupled to each modular pack of the plurality of modular packs so that each modular pack of the plurality of modular packs is arranged linearly relative to an adjacent modular pack;
a second main rail coupled to each modular pack of the plurality of modular packs opposite of the first main rail;
wherein at least one modular pack of the plurality of modular packs includes a subsystem or a component of a subsystem of the vehicle.

2. The modular chassis of claim 1, wherein a length of the modular chassis is defined by a number of modular packs included in the plurality of modular packs, and the length of the modular chassis defines a length of the vehicle.

3. The modular chassis of claim 1, wherein the subsystem or the component of a subsystem of the vehicle is at least one of: a battery pack, a battery pack module, a thermal management system, a fuel cell system, an e-axle system, and a traction drive system.

4. The modular chassis of claim 1, wherein the subsystem or the component of a subsystem is mounted on an exterior surface of the at least one modular pack of the plurality of modular packs.

5. The modular chassis of claim 1, wherein the first main rail is a side tie plate coupled to an exterior sidewall of each modular pack of the plurality of modular packs.

6. The modular chassis of claim 1, wherein the first main rail is comprised of a plurality of first rails, each first rail extending through a forward-facing wall, an interior enclosure, and a rear-facing wall of one modular pack of the plurality of modular packs to couple with an adjacent first rail of an adjacent modular pack.

7. The modular chassis of claim 6, wherein each first rail includes a plurality of fastener holes so that a distance between the one modular pack of the plurality of battery packs and the adjacent modular pack is adjustable.

8. The modular chassis of claim 1, wherein the at least one modular pack of the plurality of modular packs is a first modular pack and the subsystem or the component of a subsystem of the vehicle is a first subsystem or a first component of a subsystem of the vehicle; and
a second modular pack of the plurality of modular packs includes a second subsystem or a second component of a subsystem of the vehicle.

9. The modular chassis of claim 8, wherein the second subsystem or the second component of a subsystem of the vehicle is different from the first subsystem or the first component of a subsystem of the vehicle.

10. The modular chassis of claim 1, wherein the at least one modular pack of the plurality of modular packs includes a second subsystem or a second component of a subsystem of the vehicle.

11. A modular chassis for a vehicle, comprising:
a first subframe;
a first modular pack positioned immediately adjacent the first subframe;
a second subframe; and
a side tie plate coupled to the first subframe, the first modular pack, and the second subframe.

12. The modular chassis of claim 11, further comprising a bottom closeout removably coupled to the first subframe, the first modular pack, and the second subframe.

13. The modular chassis of claim 11, further comprising a plurality of modular pack modules.

14. The modular chassis of claim 13, wherein each modular pack of the plurality of modular packs are directly coupled to an immediately adjacent modular pack via a fastening assembly.

15. The modular chassis of claim 11, wherein at least one of the first subframe and the second subframe includes a first main rail, a second main rail, and a plurality of crossrails extending from the first main rail to the second main rail.

16. The modular chassis of claim 11, further comprising a controller mounted on at least one of the first subframe and the second subframe.

17. A modular pack for a chassis of a vehicle, the pack comprising:
a first wall;
a second wall coupled to and forming an angle with the first wall;
a third wall coupled to and forming an angle with the second wall, the third wall spaced apart from the first wall a distance corresponding with a length of the second wall;
a fourth wall coupled to and forming an angle with the first wall and the third wall;
a bottom panel extending between and coupled to the first wall, the second wall, the third wall, and the fourth wall;
a cap extending between and coupled to the first wall, the second wall, the third wall, and the fourth wall, the cap spaced apart from the bottom panel a distance corresponding with a height of at least one of the first wall, the second wall, the third wall, and the fourth wall;
an interior enclosure defined by the first wall, the second wall, the third wall, the fourth wall, the bottom panel, and the cap; and
a first rail extending across the interior enclosure between the first wall and the third wall, the first rail also extending in a first direction from the first wall exterior of the interior enclosure to define a first coupling section of the first rail and extending in a second direction from the third wall exterior of the interior enclosure to define a second coupling section of the first rail.

18. The modular pack of claim 17, wherein the first rail is spaced apart from the second wall in a direction toward the fourth wall.

19. The modular pack of claim 17, further comprising a second rail extending across the interior enclosure between the first wall and the third wall, the second rail also extending in the first direction from the first wall exterior of the interior enclosure to define a first coupling section of the second rail and extending in the second direction from the third wall exterior of the interior enclosure to define a second coupling section of the second rail.

20. The modular pack of claim 17, wherein the bottom panel defines a hollow ridge extending into the interior enclosure.
